(19) United States
(12) Patent Application Publication
(10) Pub. No.: US 2009/0092784 A1
(43) Pub. Date: Apr. 9, 2009

(54) SYNTHETIC FIBRILLAR STRUCTURE AND METHOD OF MAKING THEREOF

(75) Inventors: Anand Jagota, Bethlehem, PA (US); Nicholas J. Glassmaker, Wilmington, DE (US); Manoj K. Chaudhury, Bethlehem, PA (US)

Correspondence Address: RATNERPRESTIA, P.O. BOX 980, VALLEY FORGE, PA, 19482, US

(73) Assignee: LEHIGH UNIVERSITY, BETHLEHEM, PA (US)

(21) Appl. No.: 12/093,023

(22) PCT Filed: Nov. 21, 2006
(86) PCT No.: PCT/US06/45037

§ 371 Date: Oct. 20, 2008

Related U.S. Application Data
(60) Provisional application No. 60/739,066, filed on Nov. 22, 2005.

(51) Int. Cl. B32B 5/02; B32B 33/00; B32B 37/00; B32B 38/10

(52) U.S. Cl. 428/86; 428/85; 428/97; 428/92; 156/60; 156/249

(57) ABSTRACT

A fibrillar structure and a method of making it. The structure comprises a backing layer, a plurality of fibrils and a contacting region. The method of making it comprises constructing a synthetic fibrillar array, preparing a liquid material on a substrate and contacting the fibrillar array with the liquid material.

This application claims the benefit of earlier filed U.S. Provisional Application Ser. No. 60/739,066 file Nov. 22, 2005.

### FIELD OF THE INVENTION

The present invention relates generally to adhesion principles, and more specifically to synthetic fibrillar adhesion surfaces.

### BACKGROUND OF THE INVENTION

The ability to adhere two surfaces strongly together and then reversibly separate them, repeatedly, is a desirable capability that is rarely possible using conventional techniques. Nevertheless, fibrillar surfaces with these properties have evolved in nature on the adhesive surfaces of the feet of many lizards and insects.

Specifically, a number of biological studies have found that arrays of setae (microscopic hair-like protuberances) are a common feature on the adhesion surfaces of many lizards and insects that rely on adhesion for feeding or escaping predators. In the biological literature, the shape, dimensions, and composition of setae from various species is described. Also, the mechanical properties and adhesion force of a single gecko seta and even a single spatula (the contact surface(s) terminating a seta) were the subjects of recent investigations. An important conclusion to emerge from these two studies is that setal arrays utilize non-covalent surface forces to achieve adhesion, and evidence suggests that geckos rely primarily on van der Waals and capillary forces. As a result, the surface architecture is the primary design variable that has been adjusted in biological systems by evolution.

Because of the extraordinary adhesion ability of animals displaying setal arrays, several researchers have made efforts recently to mimic the biological setal geometry using synthetic materials. The mimic materials that have appeared so far have been simple arrays of micro-pillars made of either rubbery or stiff polymers. To date, the simple pillar mimics have not exhibited stronger adhesion than flat control surfaces of the same materials. A major reason for this is the fact that the fibrillar surfaces have a much smaller total area of contact than do the flat surfaces. In addition, the micro-pillars tend to be quite fragile and do not function when fibrils buckle, adhere laterally to other fibrils, or adhere to the adjoining structure, which are common problems, sometimes after only one load/unload cycle. Although a quantitative theoretical understanding of these issues is now available, a synthetic fibrillar mimic that improves upon a flat control has remained beyond reach.

### SUMMARY OF THE INVENTION

The present invention includes a fabricated synthetic fibrillar structure comprising a backing layer, a plurality of fibrils attached to the backing layer, each fibril having a base region adjacent the backing layer and having a cross-sectional dimension in the plane parallel the backing layer, and a contact region opposite the backing layer. The contact region has a cross-sectional dimension greater than the cross-sectional dimension of the base region of the fibrils, both cross-sections taken parallel the backing layer.

Another embodiment of this invention includes a fabricated synthetic fibrillar structure comprising a backing layer, a plurality of fibrils attached to the backing layer, each fibril having a base region adjacent the backing layer and having a cross-sectional dimension, and a contact surface opposite the backing layer. The contact surface has a surface area greater than the cross-sectional dimension of the base region of the fibril.

One embodiment of this invention includes a fabricated synthetic fibrillar structure comprising a backing layer, a plurality of fibrils attached to the backing layer, and a continuous film disposed on at least a portion of the plurality of fibrils.

Another embodiment of this invention includes a process for making a fibrillar structure comprising constructing a fibrillar array comprising a backing layer and a plurality of fibrils attached to the backing layer, providing a liquid material on a substrate and forming a contact region on at least two of the plurality of fibrils by exposing the at least two plurality of fibrils to the liquid material.

Yet another embodiment of this invention includes a process for making a fibrillar structure comprising constructing a fibrillar array comprising a backing layer and a plurality of fibrils attached to the backing layer, providing a liquid material on a substrate, forming a contact region on at least two of the plurality of fibrils by exposing the at least two plurality of fibrils to the liquid material, removing the fibrillar structure from the substrate before the liquid material is cured, whereby residual liquid material remains on the fibrillar structure, placing the exposed fibrils with residual liquid material on a clean substrate and separating the fibrillar structure from the clean substrate after the liquid material is cured.

Another embodiment of this invention includes a process for making a fibrillar structure comprising constructing a fibrillar array comprising a backing layer and a plurality of fibrils attached to the backing layer, preparing a liquid material on a substrate, forming a continuous contact region on at least two of the plurality of fibrils by exposing the at least two plurality of fibrils to the liquid material and separating the fibrillar structure from the substrate after the liquid material is cured.

### BRIEF DESCRIPTION OF THE DRAWINGS

FIG. 1 illustrates a fabricated synthetic fibrillar adhesion surface in accordance with the present invention;

FIG. 2 illustrates double cantilever beam (DCB) experimental geometry and results;

FIG. 3 illustrates indentation experimental observations;

FIG. 4 illustrates the effect of spacing on compliance and pull-off load;

FIGS. 5(a) and (b) illustrate contact pinning and a consequence;

FIGS. 6(a)-(c) illustrate a qualitative theoretical explanation of the observed behavior of the present invention;

FIG. 7 illustrates, diagrammatically, the stepwise formation of a synthetic fibrillar adhesion structure in accordance with one embodiment of the present invention;

FIG. 8 illustrates a micrograph of one embodiment of the synthetic fibrillar adhesion structure of the present invention;

FIG. 9 illustrates a micrograph of another embodiment of the synthetic fibrillar adhesion structure of the present invention;

FIG. 10 illustrates a micrograph of one embodiment of the synthetic fibrillar adhesion structure of the present invention;

FIG. 11 illustrates, diagrammatically, the stepwise formation of a synthetic fibrillar adhesion structure in accordance with another embodiment of the present invention; and

FIG. 12 illustrates a micrograph of an embodiment of the synthetic fibrillar adhesion structure of the present invention where each fibril has its own expanded contact region.

### DETAILED DESCRIPTION OF THE INVENTION

The present invention includes a synthetic fibrillar adhesion structure and method of production thereof. Advantages manifested in this invention include experimentally measured enhancement in adhesion energy of up to a factor of nine over a flat control while solving robustness problems. The present invention also has preferred contact properties, i.e. a large surface area and a highly compliant structure. The new geometry included in this invention enhances adhesion because of its ability to trap interfacial cracks in highly compliant contact regimes between successive fibril detachments. This results in the requirement that the externally supplied energy release rate for interfacial separation be greater than the intrinsic work of adhesion, in a manner analogous to lattice-trapping of cracks in crystalline solids.

The poor performance of the simple pillar mimics of setal arrays indicates that these designs do not replicate enough features of the biological systems. Indeed, while setal arrays are a unifying aspect of all the biological adhesion surfaces, each system possesses other necessary features. For example, the species Gekko gecko, displays a sophisticated sequence of increasingly compliant structures, of which setae are but a single element. Rather than focusing on this common structural element, a focus of the present invention is intended to replicate the minimum number of fundamental attributes needed by a structured adhesion surface (SAS) to function.

These attributes are brought to light by examining a typical cycle for a reusable biological SAS. First, it must make intimate contact over a large area with an opposing, possibly rough, surface. Second, to maintain contact, the adhesion between the SAS and opposing surface must be robust (e.g. insensitive to flaws) and strong enough to support the weight of the object suspended or supported. Finally, when the contact is broken, the structures must not self adhere.

In this scenario, strength and toughness are enhanced when enough setae make contact.

However, setal arrays alone are not particularly suited to making the initial contact, and as mentioned above, can be prone to self adhesion if designed improperly. One way of attaining contact is by making the system sufficiently compliant. To increase compliance using only a setal array involves increasing the setal length, or decreasing the diameter or elastic modulus, all of which can bring about setal self adhesion and buckling. Instead, biological systems have a hierarchy of compliant structures above the setae, containing a viscoelastic backing pad (the muscle tissue of the toe) that can have nearly infinite compliance in compression, which allows both conformation to the opposing surface and relaxation of stresses after initial contact. Furthermore, the highly flexible spatula elements terminating setae permit greater compliance at the contact and increase contact area for enhanced toughness. The hierarchy of compliance enhancing elements built in to the biological systems allows the setae to be sufficiently stiff to avoid self adhesion while still making enough contact to carry out the function of increasing strength and toughness.

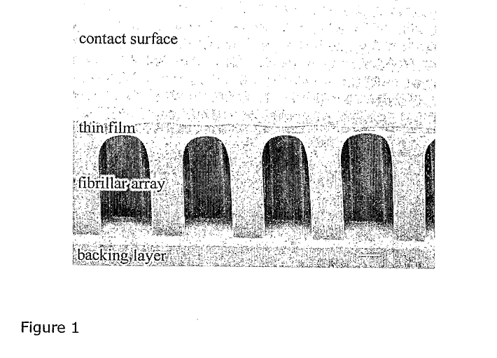

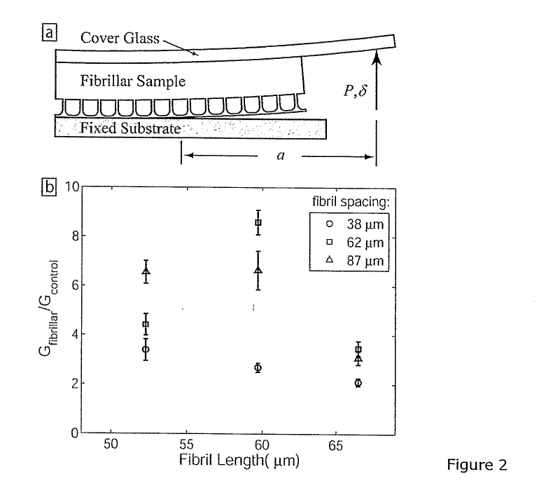

To build a hierarchy that achieves the same desired objectives as the setal adhesion system, which is anisotropic in terms of both geometry and material properties, challenges were overcome related to fabrication and applications. An embodiment of the invention presents new architecture, as shown in FIG. 1, which is beneficial for attaining maximal contact, enhancing adhesion, and avoiding self adhesion and buckling. More specifically, the structure of FIG. 1. represents a fabricated synthetic fibrillar adhesion surface consisting of an array of micro-pillars including a terminal film or contact region disposed on the ends of the fibrils. The scale-bar represents a distance of 10 μm. FIG. 2. shows DCB experimental geometry and results. Shown is: (a) modified double cantilever beam experimental geometry (displacement δ is controlled while the load P and crack length a are measured); (b) normalized energy release rate G calculated from the data using Equation 1 (below) and presented as a function of fibril length and spacing. Results are quotients of mean values, with five trials performed to obtain each mean. Error bars were calculated by assuming both fibrillar and control samples have random, independent uncertainty of one standard deviation.

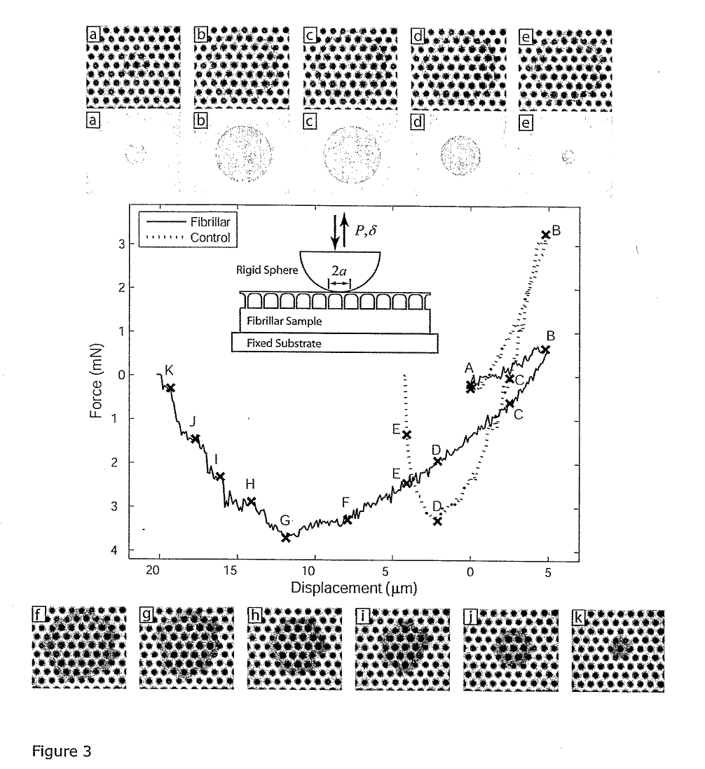

FIG. 3 shows indentation experimental observations. The plot shows typical force-displacement data for shallow indentation of a flat control and a fibrillar sample (fibril length=60 μm, nearest neighbor spacing=62 μm). Inset to the plot shows the geometry of the indentation experiment. Displacement δ is controlled while the load P and contact radius a are measured. (Compressive force and displacement into the sample are taken to be positive.) Relative displacement between the indenter and sample increases initially until an indentation depth of 5 μm is reached and then decreases until complete separation occurs. Photos (a)-(k) correspond to points indicated in the force vs. displacement curves. The fibrillar sample is considerably more compliant under compression, evidenced by its lower maximum compressive load, and sustains much greater tensile displacement before detaching from the indenter.

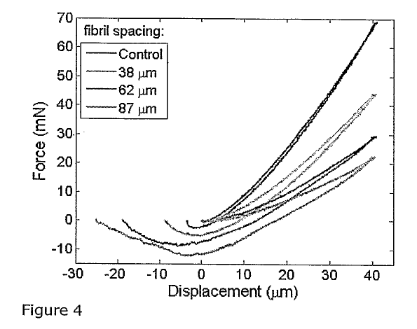

FIG. 4 illustrates the effect of spacing on compliance and pull-off load. Indentation data is shown for specimens with different inter-fibrillar spacing and fixed fibril height. It is clear that the compliance and loading-unloading hysteresis both increase with increasing spacing between fibrils. Maximum pull-off load also increases with increasing spacing between fibrils.

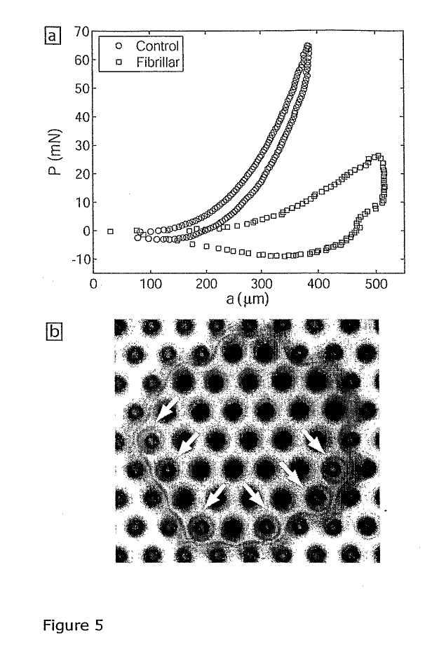

FIGS. 5(a) and (b) show contact pinning and a consequence. FIG. 5(a) shows load P versus contact radius a for the indentation experiment and reveals strong hysteresis in the fibrillar sample due to crack trapping. During retraction, a decreases with P for the control sample, while it remains nearly constant until tensile values of P are reached for the fibrillar sample (fibril length=60 μm, nearest neighbor spacing=62 μm). The experimental geometry is shown in FIG. 3, inset to the plot. FIG. 5(b) illustrates image (f) from FIG. 3 at larger magnification. Note that interfacial cavitation occurs under several fibrils ahead of the pinned crack tip as the indenter is retracted. Cavities are indicated by arrows. Nucleation of voids indicates a large tensile stress in front of the crack tip, a situation that occurs when the crack tip is pinned between fibrils while the external load continues to increase.

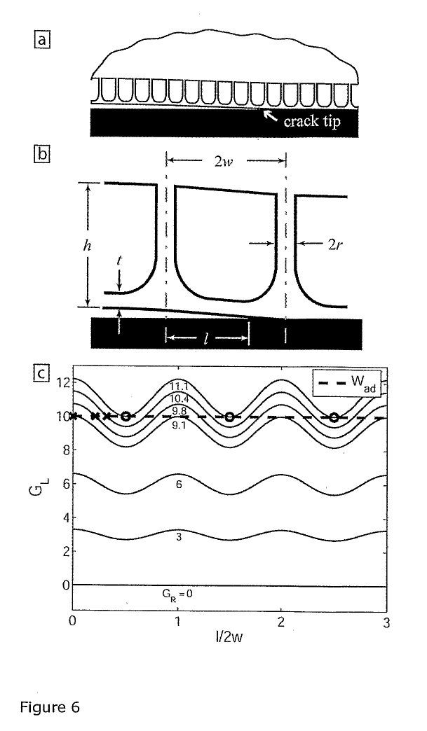

FIGS. 6(a)-(c) represent a qualitative theoretical explanation of the observed behavior. FIG. 6(a) shows an approximation of the fibrillar system in two dimensions. A semi-infinite crack extends along the interface between a fibrillated semi-infinite elastic body with a terminal film. FIG. 6(b) shows the geometry of the repeating unit cell within the fibrillar strip and its associated geometric variables. FIG. 6(c) shows a variation of the local energy release rate available to the crack tip G_{L} as a function of the crack length /. This example assumes a constant remotely supplied energy release rate G_{R} and a sinusoidal variation due to the absorption and expulsion of energy by the fibrillar strip. The ‘×’ marks indicate stable equilibrium crack positions, while the ‘◯’ marks indicate unstable ones. Note that when the crack propagates between unstable equlibria, G_{R}>W_{ad}.

Returning to the benefits of adding the terminal film to the fibrillar array, recall that this structure maximizes the area of the contact surface and maintains the separation and uprightness of the pillars. This last benefit results because there is an energy penalty associated with stretching the contact region that prevents neighboring fibrils from adhering to each other or to the backing layer in FIG. 1. In one embodiment, due to its thinness and concomitant flexibility, the contact region tends to increase compliance locally, which allows intimate contact with the adherend to be attained with ease and maintained more tenaciously. The fact that the contact region is so compliant also means that it transfers very little load to the tip of a crack between successive fibril detachments. As illustrated, this has a highly advantageous halting effect on interfacial crack propagation.

This invention includes a process of making the fibrillar structures. In one embodiment, a fibrillar array was constructed by molding poly(dimethylsiloxane) (PDMS) into lithographically etched silicon, as described previously. The array was placed onto a liquid PDMS film obtained by spin coating. After the liquid partially wet the fibrillar array, it was cured in place to obtain the final shape. The fibrils had square cross-sections with 14 μm sides, and fibril length was varied between 50 and 65 μm. The array of fibrils was arranged in a hexagonal pattern, with center to center spacing distance between fibrils set at 38, 62, or 87 μm. The terminal film had a thickness of approximately 4 μm. PDMS has an elastic modulus of about 3 MPa and surface energy of about 20 mJ/m².

This invention is distinguished from natural setae in lizards because this invention can be made from a variety of materials including, but not limited to, synthetic polymers and thin metals such as: synthetic and natural elastomers, stiff polymers such as polystyerene, polymethylmethacrylate, metals such as aluminum, copper or steel. The lower modulus results in significant stretching of the fibrils and backing layer under tension during pull off. Some of this stored elastic energy is then dissipated during an elastic instability, due to the unique geometry included in the invention. While it is still unclear that this scheme is employed by biological setal systems, a result of this invention includes better adhesion because of the use of a softer material compared to the keratin protein of animal setae.

Adhesion of synthetic samples was measured in two ways. One was a modified version of the double cantilever beam (DCB) fracture experiment. The second was an indentation experiment using a spherical indenter.

In the DCB experiment (FIG. 2), a glass beam was displaced upward at a constant rate at a point near its right-hand edge and the force P at this point was measured. Eventually, when the force became large enough, the interface between the contact surface of the sample and the substrate began to separate, beginning at the right. A camera was placed above the transparent sample to record the distance a from the separation front to the load point. With these data, the work per unit area necessary to advance the crack G could be calculated from:

$$G = \frac{1}{B} \frac{d }{d a} ( {\int }_{0}^{δ} P ( \overline{δ} ) d \overline{δ} - P δ / 2 ) , \qquad [ 1 ]$$

where B is the width of the sample. The first term in parentheses is the total work input to the system, and the second term is the stored elastic energy. The latter assumes a linear force displacement response when the crack tip is stationary, which is verified by the experiments as a very good assumption for the glass/PDMS samples.

Shown in FIG. 2 is the measured energy release rate, found using Eq. 1 with the experimental data. Notice that the fibrillar samples have a measured energy release rate that clearly exceeds that of a flat control, by a factor of 2-9. The flat control samples were fabricated together with the fibrillar samples using the same method and materials, except flat, unstructured PDMS replaced the fibrillar array in the control samples. The mean value of adhesion energy obtained for the control samples was 137 mJ/m², although there was significant variation from wafer to wafer (standard deviation for 5 wafers was 38 mJ/m²). Fibrillar adhesion values were normalized by the appropriate control sample fabricated on the same wafer.

From FIG. 2, it is difficult to decipher the role of fibril length on the measured adhesion due to the narrow range of lengths tested. However, the spacing between fibrils certainly affects the adhesion. It is clear from FIG. 2 that the lowest values of normalized energy release rate are observed for the smallest spacing. Beyond that the data are less conclusive, although both the 62 and 87 μm spacing samples show significantly greater enhancement.

The indentation experiment, as shown in FIG. 3, inset in plot, may shed light on why this invention adheres better than its flat counterpart. The indentation experiment allows direct, microscopic visualization of the contact interface during both healing and separation. In this experiment, a spherical indenter is pressed into contact at a constant displacement rate (1 μm/s). The plot in FIG. 3 shows an example of the measured force as a function of displacement for a very slight indentation. After the initial contact, the compressive force increases in magnitude. The magnitude of the compressive force then decreases as the indenter is retracted at the same displacement rate. Eventually, the force becomes tensile due to adhesion between the indenter and sample. After a maximum tension is reached, the situation becomes unstable and contact is lost.

The contact area during the indentation is viewed via an inverted optical microscope. Still images in FIG. 3 show the contact area at various points along the load vs. displacement curve. There are several substantial differences between the fibrillar and control samples. For the flat control sample, the contact area is circular, as expected for the spherical indenter. In the case of the fibrillar sample, the contact region resembles a hexagon at most points, due to the patterning of the fibrils. Also, note that the maximum compression force is significantly reduced for the fibrillar sample compared to the flat control at the same depth of indent, and the contact area is larger. Both of these observations indicate a larger compliance for the fibrillar sample. In fact, compliance increases systematically with increasing fibril spacing. FIG. 4 demonstrates force-displacement responses for deeper indentations of a sequence of samples differing only in fibril spacing. A similar trend was obtained for samples of three different fibril lengths.

In control samples, the contact area increases continuously with indentation depth and begins decreasing immediately when retraction of the indenter begins. In contrast, for the fibrillar sample there is strong hysteresis in the sense that the contact area remains pinned at the maximum value it achieved on compression nearly until the point of maximum tension. This “contact pinning” is evident from a comparison of (d) and (g) in FIG. 3, where it is seen that the contact area is significantly reduced at the point of maximum tension for the control and nearly maximal for the fibrillar sample. FIG. 5a better demonstrates contact pinning for a deeper indent. Notice in that plot that during retraction, the measured area clearly remains almost constant for the fibrillar sample, until the force is reduced to about 10 mN.

Parts (h)-(k) of FIG. 3 demonstrate the phenomena closely related to the contact pinning effect that occur after the point of maximum tension. Whereas the circular contact shrinks continuously for the flat control, the fibrillar sample decoheres incrementally in a more controlled way, with each hexagonal contact pinned as a temporary point of stability. In fact, the contact remains stable until the region around only a single fibril is in contact. See the photos in FIG. 3(h)-(k), and also note the step-like load reduction between the corresponding points on the load vs. displacement curve.

Practically, contact pinning is an important mechanism that increases the adhesion of fibrillar interfaces. In addition to the DCB results shown in part (b) of FIG. 2, enhanced adhesion was also observed in the indentation experiments on the same samples. Compared to corresponding flat controls, the pull-off force of the indenter was found to be a factor of 1.5-3.5 times greater for the fibrillar samples. The role of fibril spacing was clearer from the indentation data than the DCB results; increased fibril spacing consistently resulted in increased pull off force (FIG. 4). Complementary to the pull-off force results are findings regarding adhesion hysteresis, another measure of adhesion performance. As one can see from FIG. 4, the mismatch between indentation and retraction force traces increases with fibril spacing. As a result, more work is required to fail the fibrillar samples, and the amount increases systematically with increased fibril spacing. Note the somewhat surprising aspect of these results, i.e. both pull off force and adhesion hysteresis increase as the fibril density decreases; previous models for adhesion enhancement in fibrillar interfaces, based on a fixed amount of energy loss per fibril, would predict a decrease in adhesion with decreasing fibril density.

A qualitative theoretical explanation may explain why contact pinning directly results in enhanced adhesion in the fibrillar sample. Consider a two dimensional version of the fibrillar array with a terminal film, as shown in FIG. 6(a). Assume the fibrils are backed by a semi-infinite medium of the same elastic material and that the film makes contact with a fixed, rigid surface. Also, assume a semi-infinite crack extends along the interface.

Consider the energetics of extending the crack along the interface. First, recall that the thermodynamic work of adhesion W_{ad} is the energy per unit area required to separate an interface, a property only of the two contacting surfaces. Thus, the condition that must be satisfied in order for the crack to be in stable equilibrium is

$${G}_{L} = {W}_{ad} , \frac{d {G}_{L}}{d l} < 0 , \qquad [ 2 ]$$

where G_{L} is the elastic strain energy released locally from the material just adjacent to the crack tip, per unit length of an infinitesimal extension of the crack, and / is the crack length measured from an arbitrary datum.

Next, note that because of the periodic nature of the fibrillar microstructure near the interface, the rate of energy release G_{L} available from the material will vary periodically as a function of crack position. Specifically, the strip of material near the interface containing the fibrillar array will alternately absorb and expel energy, depending on the location of the crack tip within the repeating geometric cell shown in FIG. 6b. If energy is input to the system remotely at a rate G_{R} per unit length of crack extension, then by energy conservation, one has

$${G}_{L} = {G}_{R} - \frac{d {W}_{s}}{d l} , \qquad [ 3 ]$$

where Wₛ is the elastic strain energy stored in the fibrillar strip. That is, the remote supply of energy is either absorbed by the fibrillar strip (dWₛ/dl>0), or is available to do the work of extending the crack in the term G_{L}. In the case where the fibrillar strip is releasing energy (dWₛ/dl<0), there is extra energy available to propagate the crack, beyond that supplied remotely. Observations from the indentation experiment indicate that energy is released from the strip whenever the crack passes under a fibril (dWₛ/dl<0) and absorbed when the crack is between fibrils (dWₛ/dl>0).

The variation in energy release rate indicated by Eq. 3 is analogous to the phenomenon of lattice trapping of a crack, which has the consequence of enhanced work of fracture and irreversibility. In lattice trapping, the energy release rate available to drive the crack is a given monotonic function, while the local work of adhesion varies periodically with crack length. By contrast, in this system, the converse is true, since the variability arises due to periodic storage and release of elastic strain energy. In this case, it is reasonable to assume that the periodic energy storage and release rate will scale with the remote loading, or

dWₛ/dl=αG_{R}, [4]

where α is a dimensionless function of the geometry of the strip of fibrils. α must be periodic in / with period 2w, i.e., as the crack traverses a periodic cell the work absorbed equals the work released so that

$${\int }_{0}^{2 w} \frac{d {W}_{s}}{d l} d l = 0. \qquad [ 5 ]$$

(Note that 2w is the spacing between fibrils. See FIG. 6(b).

Making use of Eq. 5 in Eq. 2, integration of Eq. 3 results in

$${W}_{ad} = \frac{1}{2 w} {\int }_{0}^{2 w} {G}_{R} d l = {\overline{G}}_{R} , \qquad [ 6 ]$$

where G̅_{R} is the mean value of the externally supplied energy release rate. Eq. 6 states that if the crack always propagates stably, there will be no enhancement in macroscopically measured adhesion; this is a requirement for a purely elastic material. However, this is highly unlikely because it would require constant and automatic adjustment of the remote loading system. More realistically, remote loading will change monotonically and in that case the crack will be forced to open at a higher value of remote energy release rate.

### An Illustrative Example:

Let G_{R} be constant and let α=ε cos(πl/w). Eqs. 3 and 4 then determine G_{L}, which is plotted versus / for various values of G_{R} in FIG. 6c. (The corresponding value of G_{R} is indicated next to each G_{L} curve in FIG. 6c.) For the system in FIG. 6c, W_{ad}=10 and ε=0.1, so that Eq. 2 is not satisfied for G_{R}<10/1.1, meaning the crack heals for G_{R}<10/1.1. When G_{R}=10/1.1≈9.1, the upper peak of the G_{L} curve just satisfies Eq. 2. The equilibrium is stable, thus the crack cannot move beyond l=0.

To move the crack, G_{R} must be increased. As shown in FIG. 6c, the crack extends to the values of / indicated by “×” marks for G_{R}=9.8 and 10.4. These crack extensions are stable, because dG_{L}/dl<0, i.e., further extension of / beyond the “X” in each case results in available energy release rate being less than the work of adhesion. For G_{R}=10/0.9≈11.1, however, the crack extends to the first “◯” mark. Now the situation is different, since dG_{L}/dl is non-negative at the first equilibrium location. Any further increase in G_{R} results in unstable crack growth.

It is now clear why Eq. 6 is generally unattainable in experiments. The instabilities cause the crack to run at a higher value of G_{R} than would be necessary for stable crack growth. For Eq. 5 to be true, it would be necessary to set up an elaborate control system that precisely raises or lowers G_{R} so that G_{L}=W_{ad} at all crack lengths. Moreover, if one measured the energy release rate upon crack healing, the argument also holds in reverse, so that G̅_{R} generally will be less than W_{ad} upon healing, via a similar argument.

This demonstration of how a periodic structure can lead to hysteresis in a purely elastic material is very similar to the lattice trapping calculations previously mentioned. The difference in the G_{R} necessary to advance and retract a crack is the reason for the contact pinning displayed in FIGS. 3 and 5a.

For a fixed value of work of adhesion, the required remote energy release rate for unstable crack propagation is maximized when dWₛ/dl (or α) is maximized. When the crack tip is between fibrils, the energy release rate available to it is mediated by the thin film, and scales as t³ if the film is modeled as a plate, where t is the film thickness. As t becomes vanishingly small, G_{L}→0 so that, in order to advance the crack, G_{R}→∞. Physically, this means that the plate is too thin to transfer energy to the crack tip. Of course, in reality, G_{R} does not go to infinity. Rather, as G_{R} becomes large, a very large tensile stress will develop under the fibrils directly ahead of the crack tip. This stress will eventually become large enough to nucleate an interfacial void or cavity underneath the fibril. Failure of the interface will then proceed due to the propagation of these voids. Note in FIG. 5b that voids do in fact nucleate ahead of the opening crack tip in several instances, as is the case with thin soft films in confined geometry. Failure by void nucleation represents the maximum enhancement possible by the mechanism proposed here and is limited by individual fibril detachments, a situation that has been studied in detail elsewhere.

Through the addition of a highly compliant terminal film, the structure of the present invention improves on previous mimics of biological setae in that it has a larger surface area and is more robust. Moreover, two experiments confirm it is the first to enhance adhesion over a flat control of the same material. Fibrillar samples provided an enhancement factor of 2-9 in the adhesion energy release rate and greatly increased contact compliance over the controls. Experiments also showed that the fibrillar geometry tends to pin the contact upon retraction and fails incrementally in a more stable way than the flat control. A qualitative theory may explain the findings and showed the behavior of our material at the micrometer scale is similar to lattice trapping behavior observed at the atomic scale in brittle elastic solids.

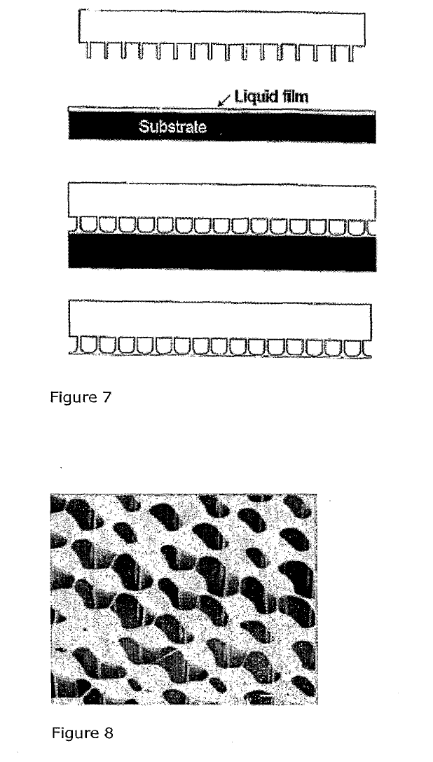

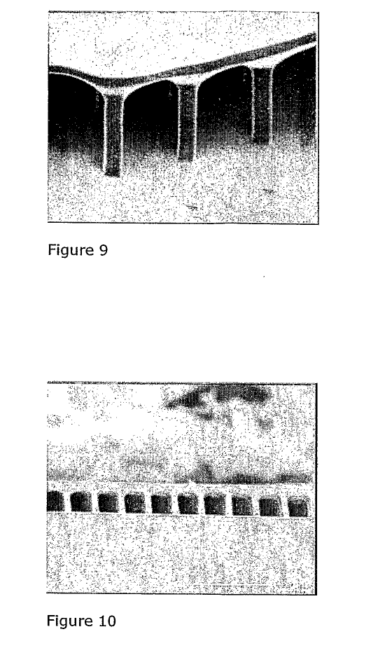

This invention includes a process for making a fabricated synthetic fibrillar structure. In one embodiment, this invention includes a process for making a fibrillar structure comprising constructing a fibrillar array comprising a backing layer and a plurality of fibrils attached to the backing layer, preparing a liquid material on a substrate, forming a continuous contact region on at least two of the plurality of fibrils by exposing the at least two plurality of fibrils to the liquid material and separating the fibrillar structure from the substrate after the liquid material is cured. This is shown diagrammatically in FIG. 7 and forms a continuous or relatively continuous contact region on the ends of the fibrils. FIGS. 8, 9 and 10 are micrographs showing the resultant continuous or semi-continuous film or contact region produced by this method. This methodology is expanded upon below.

To facilitate easy removal, a self-assembled monolayer (SAM) of the molecule n-hexadecyltrichlorosilane was introduced as follows. The surface was cleaned with a solution of 70% H₂SO₄, 15% H₂O₂, 15% H₂O for 30 minutes. The surface was rinsed with deionized water and dried with N₂. Then, it was cleaned with oxygen plasma, at a low enough power density to avoid introducing any roughness on the surface. The surface was placed in an evacuated chamber (20 mTorr) with an open vessel containing n-hexadecyltrichlorosilane liquid for 1 hour.

Next, a PDMS fibrillar array was fabricated. Arrays of square cross-sectioned holes of the desired dimensions (5-15 μm sides) were introduced into silicon wafers via standard photolithography and deep reactive ion etch techniques. The depth of the holes was determined by the etch time and ranged from 50 to 65 μm. These Si “master” wafers were used to mold PDMS into pillars, as follows.

A hydrophobic SAM was formed on the surface of a Si master as described above, making it a very low energy surface and enabling the subsequent release of molded PDMS. PDMS (Sylgard 184, Dow Corning) was cast in liquid form (10:1 mass ratio of elastomer base to curing agent) against the Si master. To ensure a backing layer of uniform thickness behind the fibrillar array, feeler gage stock was used to space a confining glass slide 0.635 mm away from the Si master. The PDMS was then cross-linked in the mold by heating to 80° C. for >1 hour. To facilitate removal of the array of PDMS posts from the master, the entire structure was cooled in dry ice (−78.5° C.) for 1 hour after curing was complete. The fibrillar PDMS sample was then removed manually from the master.

A contacting film was then fabricated. A SAM of n-hexadecyltrichlorosilane was prepared on a silicon wafer as described above. PDMS liquid was spin-coated on the wafer, with the thickness of the PDMS liquid film controlled by the spin speed. A film was with a thickness of ≈4 μm for a spin speed of 6000 RPM. The fibrillar array was placed manually into the liquid film. Because both the fibrillar array and liquid film are PDMS, the liquid wets the fibrillar array, so that some of the liquid in the film coats the fibrillar array. The liquid PDMS film is then cross-linked at 80° C. for >1 hour. After curing is complete, the fibrillar array and terminal film, now a single structure, may be removed from the SAM on Si surface manually, as shown in FIG. 7.

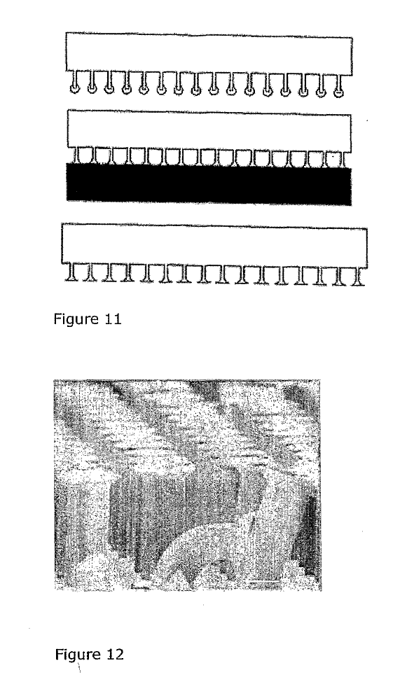

As noted above, in another embodiment of this invention, a non-continuous contact region can be generated at the ends of the fibrils. Such an embodiment is shown in the micrograph of FIG. 12 and FIG. 8. FIG. 11 shows a method of producing such a structure, and is similar to that discussed above with regard to the continuous contact film, except that the fibrils are exposed to the liquid material and then removed or separated from the liquid before it is cured. This causes some of the liquid material to remain on the fibrils in residual amounts. As shown diagrammatically in FIG. 11, the exposed fibrils with residual liquid material are pressed to a clean substrate at which time the curing is allowed to occur. After curing, the fibrillar structure is separated from the clean substrate and the resultant “elephant foot” or “trumpet flare” top configuration is achieved, as shown in the micrograph of FIG. 12.

Although the invention is illustrated and described herein with reference to specific embodiments, the invention is not intended to be limited to the details shown. Rather, various modifications may be made in the details within the scope and range of equivalents of the claims and without departing from the invention.

What is Claimed:

1. A fabricated synthetic fibrillar structure comprising:
a backing layer;
a plurality of fibrils attached to the backing layer, each fibril having a base region adjacent the backing layer and having a cross-sectional dimension, and a contact region opposite the backing layer;
the contact region having a cross-sectional dimension greater than the cross-sectional dimension of the base region of the fibril.

2. The structure of claim 1 wherein the contact region is disposed on more than one fibril.

3. The structure of claim 1 wherein the fibrils are polymeric.

4. The structure of claim 3 wherein the polymer has an elastic modulus of from about 10 GPa to about 100 kPa.

5. The structure of claim 4 wherein the polymer is poly(dimethylsiloxane).

6. The structure of claim 3 wherein each fibril has a length of about 50 μm to about 65 μm.

7. The structure of claim 1 wherein each fibril has a center to center spacing distance of about 30 μm to about 90 μm.

8. A fabricated synthetic fibrillar structure comprising:
a backing layer;
a plurality of fibrils attached to the backing layer, each fibril having a base region adjacent the backing layer and having a cross-sectional dimension, and a contact surface opposite the backing layer, the contact surface having a surface area greater than the cross-sectional dimension of the base region of the fibril.

9. The structure of claim 8 wherein the fibrils are polymeric.

10. The structure of claim 10 wherein the polymer has an elastic modulus of from about 10 GPa to about 100 kPa.

11. The structure of claim 10 wherein the polymer is poly(dimethylsiloxane).

12. A fabricated synthetic fibrillar structure comprising:
a backing layer;
a plurality of fibrils attached to the backing layer; and
a continuous film disposed on at least a portion of the plurality of fibrils.

13. The structure of claim 12 wherein the fibrils are polymeric.

14. The structure of claim 13 wherein the polymer has an elastic modulus of from about 10 GPa to about 100 kPa.

15. The structure of claim 15 wherein the polymer is poly(dimethylsiloxane).

16. A process for making a fibrillar structure comprising:
(a) constructing a fibrillar array comprising a backing layer and a plurality of fibrils attached to the backing layer;
(b) providing a liquid material on a substrate;
(c) forming a contact region on at least two of the plurality of fibrils by exposing the at least two plurality of fibrils to the liquid material.

17. The process according to claim 16 wherein the liquid material is spin coated on the substrate.

18. The process according to claim 17 wherein the liquid material is a polymer.

19. The process according to claim 18 wherein the polymer has an elastic modulus of from about 10 GPa to about 100 kPa.

20. The process according to claim 16 wherein the fibrillar array is constructed of the same material as the liquid material.

21. A process for making a fibrillar structure comprising:
(a) constructing a fibrillar array comprising a backing layer and a plurality of fibrils attached to the backing layer;
(b) providing a liquid material on a substrate;
(c) forming a contact region on at least two of the plurality of fibrils by exposing the at least two plurality of fibrils to the liquid material;
(d) separating the fibrillar structure from the substrate before the liquid material is cured, whereby residual liquid material remains on the fibrillar structure;
(e) placing the exposed fibrils with residual liquid material on a clean substrate;
(f) separating the fibrillar structure from the clean substrate after the liquid material is cured.

22. The process according to claim 21 wherein the liquid material is spin coated on the substrate.

23. The process according to claim 21 wherein the liquid material is a polymer.

24. The process according to claim 23 wherein the polymer has an elastic modulus of from about 10 GPa to about 100 kPa.

25. The process according to claim 21 wherein the fibrillar array is constructed of the same material as the liquid material.

26. A process for making a fibrillar structure comprising:
(a) constructing a fibrillar array comprising a backing layer and a plurality of fibrils attached to the backing layer;
(b) providing a liquid material on a substrate;
(c) forming a continuous contact region on at least two of the plurality of fibrils by exposing the at least two plurality of fibrils to the liquid material;
(e) separating the fibrillar structure from the substrate after the liquid material is cured.

27. The process according to claim 26 wherein the liquid material is spin coated on the substrate.

28. The process according to claim 27 wherein the liquid material is a polymer.

29. The process according to claim 28 wherein the polymer has an elastic modulus of from about 10 GPa to about 100 kPa.

30. The process according to claim 27 wherein the fibrillar array is constructed of the same material as the liquid material.
